(19) United States
(12) Patent Application Publication
(10) Pub. No.: US 2002/0139606 A1
(43) Pub. Date: Oct. 3, 2002

(54) Electric power steering system including a segmented stator switched reluctance motor

(76) Inventors: Donald J. Williams, Pierron, IL (US); James A. Wafer, Belleville, IL (US); Marielle Piron, Harrogate (GB); Michael L. McClelland, Leeds (GB)

Correspondence Address: HARNESS, DICKEY & PIERCE, P.L.C., P.O. BOX 828, BLOOMFIELD HILLS, MI, 48303, US

(21) Appl. No.: 09/824,980

(22) Filed: Apr. 3, 2001

(51) Int. Cl. B62D 5/04

(52) U.S. Cl. 180/446; 180/443

(57) ABSTRACT

An electric power steering system for a vehicle includes a steering wheel, a steering shaft connected to said steering wheel, and a switched reluctance motor coupled to said steering shaft. The switched reluctance motor includes a segmented stator having a plurality of stator segment assemblies that define salient stator poles and inter-pole stator slots. Each of the stator segment assemblies includes a stack of stator plates defining a stator segment core, an end cap assembly, and winding wire that is wound around the stator segment core and the end cap assembly. The rotor tends to rotate relative to the stator to a rotational position that maximizes the inductance of an energized winding. A drive circuit energizes the winding wire around the stator segment assemblies based on the rotational position of the rotor.

### FIELD OF THE INVENTION

This invention relates to electric power steering systems and, more particularly to electric power steering systems that include a switched reluctance electric motor with a segmented stator.

### BACKGROUND OF THE INVENTION

Electric power steering (EPS) systems for vehicles such as automobiles and trucks typically include a steering wheel, a motor, a controller, one or more sensors, a steering shaft, and a steering gear assembly such as a rack and pinion gear assembly or a recirculating ball steering gear assembly. The motor is coupled to the steering shaft through a worm that is connected to the motor and a worm gear that is connected to the steering shaft. The sensors typically include a torque sensor that provides a feedback signal to the controller that represents driver effort that is required to turn the steering wheel. As the driver effort increases, the motor turns the worm which, in turn, turns the worm gear that is connected to the steering shaft. The motor reduces driver effort that is required to turn the steering wheel. Other sensed parameters typically include a rotational sensor that senses shaft rotational position and that provides a feedback signal to the controller. Vehicle velocity is also typically input to the controller so that the assist provided by the EPS system varies as a function of vehicle speed.

EPS systems offer improvements over conventional hydraulic assist systems by reducing overall vehicle weight and improving fuel economy. In addition, EPS systems allow for precise electronic control of the steering system. In addition to variable effort assist, the EPS system can also provide steering wheel return characteristics that may be tuned to a desired feel and/or responsiveness. The amount of tactile feedback to the driver through the steering wheel may also be electronically controlled. Specifically, the steering torque provides information to the driver regarding road conditions and vehicle maneuverability. The amount of restoring torque is a function of the chassis design and the transmissibility of rack loads back to the steering wheel. The EPS system provides active control of the transmissibility characteristics and therefore the amount of tactile feedback to the driver.

Switched reluctance motors have not typically been used in EPS systems for several reasons. Reluctance motors typically include a stator that is mounted inside a motor housing and a rotor that is supported for rotation relative to the stator. Reluctance motors produce torque as a result of the rotor tending to rotate to a position that maximizes the inductance of an energized winding of the stator. As the energized winding is electrically rotated, the rotor also rotates in an attempt to maximize the inductance of the rotating energized winding of the stator. In synchronous reluctance electric motors, the windings are energized at a controlled frequency. In switched reluctance electric motors, control circuitry and/or transducers are provided for detecting the angular position of the rotor. A drive circuit energizes the stator windings as a function of the sensed rotor position.

The design and operation of switched reluctance electric motors is known in the art and is discussed in Stephenson and Blake, “The Characteristics, Design and Applications of Switched Reluctance Motors and Drives”, presented at the PCIM '93 Conference and Exhibition at Nuremberg, Germany, Jun. 21-24, 1993, which is hereby incorporated by reference.

In switched reluctance electric motors, a rotor position transducer (“RPT”) is often used to detect the angular position of the rotor with respect to the stator. The RPT provides an angular position signal to the drive circuit that energizes the windings of the switched reluctance electric motor. The RPT typically includes a sensor board with one or more sensors and a shutter that is coupled to and rotates with the shaft of the rotor. The shutter includes a plurality of shutter teeth that pass through optical sensors as the rotor rotates.

Because rotor position information is critical to proper operation of a switched reluctance electric motor, sophisticated alignment techniques are used to ensure that the sensor board of the RPT is properly positioned with respect to the housing and the stator. Misalignment of the sensor board is known to degrade the performance of the electric motor. Unfortunately, utilization of these complex alignment techniques increases the manufacturing costs for switched reluctance electric motors equipped with RPTs.

The RPTs also increase the overall size of the switched reluctance electric motor, which can adversely impact motor and product packaging requirements. The costs of the RPTs and their related manufacturing costs often place switched reluctance electric motors at a competitive disadvantage in EPS system applications that are suitable for less costly induction electric motors.

Another drawback with RPTs involves field servicing of the switched reluctance electric motors. Specifically, wear elements, such as the bearings, located within the enclosed rotor housing may need to be repaired or replaced. To reach the wear elements, an end shield must be removed from the housing. Because alignment of the sensor board is critical, replacement of the end shield often requires the use of complex realignment techniques. When the alignment techniques are improperly performed by the service technician, the sensor board is misaligned and the motor's performance is adversely impacted.

In an effort to eliminate the RPTs and to reduce manufacturing costs and misalignment problems, “sensorless” techniques for sensing rotor position have been developed. Sensorless techniques detect the magnitude of the back-electromotive force (EMF) of an unenergized winding of the stator in the switched reluctance electric motor. The windings are commutated when the sensed EMF magnitude reaches a predetermined level. Several patents disclosing sensorless techniques for sensing rotor position in switched reluctance electric motors include U.S. Pat. No. 5,929,590 to Tang and U.S. Pat. No. 5,877,568 to Maes, et al. which are hereby incorporated by reference. Application of the sensorless techniques is limited by the relatively low back-EMFs induced in the unenergized stator windings that are associated with switched reluctance electric motors. Additional problems with the sensorless techniques are attributable to variations in the inductance and resistance of the stator windings due to assembly and tolerance variations.

Conventional switched reluctance motors generally include a plurality of stator plates that are punched from a magnetically conducting material. The stator plates have a circular cross-section and are stacked together to form the stator. The stator plates define salient stator poles that project radially inward and inter-pole slots that are located between adjacent stator poles. Winding wire is wound around the stator poles. There are several methods for placing the winding wire on the stator of a switched reluctance motor. The winding wire can be initially wound and transferred onto the stator poles. Transfer winding tends to leave excess winding wire or loops around axial ends of the stator poles. Transfer winding can typically utilize approximately 60-65% of available stator slot area. Needle winding employs a needle that winds the wire directly on the stator poles. The needle, however, takes up some of the stator slot area, which reduces slot fill to approximately 50%. The positioning of winding wire on the stator poles using these methods varies from one stator pole to the next. Winding creep and other assembly variations also impact the inductance and resistance of the winding wire over time, which makes it difficult to accurately perform “sensorless” control due to the non-conformity of the salient stator poles.

The design of EPS systems can be improved in several areas. Specifically, it is desirable to improve the torque density of switched reluctance electric motors that are employed by the EPS systems. By increasing the torque density, the size of the EPS systems can be reduced for a given torque output and/or the size can be maintained with an increase in torque output. Alternately, increased slot fill reduces the required battery current for a given torque and speed. EPS systems achieving higher torque density will allow designers of products equipped with EPS systems greater flexibility in product design that may lead to increased sales through product differentiation, improved performance, reduced weight, and/or improved profit margins.

It would be desirable to eliminate the need for RPTs in switched reluctance electric motors that are employed by the EPS systems. It would also be desirable to assemble the stator of a switched reluctance electric motor used in the electric power steering assist systems in a highly uniform and repeatable manner to improve the performance of sensorless switched reluctance motors by reducing variations in the inductance and resistance of the stator.

### SUMMARY OF THE INVENTION

An electric power steering system for a vehicle includes a steering wheel, a steering shaft connected to said steering wheel, and a switched reluctance motor coupled to said steering shaft that reduces driver effort to turn said steering wheel. The switched reluctance motor includes a segmented stator having a plurality of stator segment assemblies. The stator segment assemblies define salient stator poles and inter-pole stator slots. Each of the stator segment assemblies includes a stack of stator plates defining a stator segment core, an end cap assembly supporting the stator segment core, and winding wire which is wound around the stator segment core and the end cap assembly. The rotor defines a plurality of rotor poles. The rotor tends to rotate relative to the stator to maximize the inductance of an energized winding. A drive circuit energizes the winding wire around the stator segment assemblies based on a rotational position of the rotor.

According to other features of the invention, a worm gear is connected to the steering shaft, a worm is threadably engaged to the worm gear, and the switched reluctance motor is connected to said worm.

According to other features of the invention, each stator plate has an outer rim section and a tooth-shaped pole section. A tongue and groove connection is provided for connecting the outer rim section of the stator segment cores that are associated with adjacent stator segment assemblies to define the segmented stator.

As a further feature of the invention, the end cap assembly includes a pair of end caps that are secured to opposite ends of the stator segment core, and a pair of retainer plates interconnecting the end caps on opposite sides of the stator segment core. The end cap assembly defines an annular retention channel within which the winding wire is wound. The retention channel facilitates improved precision in the winding process and tends to reduce winding creep during use.

The electric power steering system according to the present invention includes a switched reluctance electric machine with improved torque density. As a result, the torque output of the switched reluctance electric machine can be increased for increased steering assist and/or the dimensions of the switched reluctance electric machine can be reduced for a given torque output to reduce weight and outer dimensions of the electric power steering system. In addition, the stator segment assemblies can be manufactured with greater uniformity and with lower variations in inductance and resistance. Sensorless rotor position sensing techniques can be employed to dramatically lower the manufacturing costs of the switched reluctance machine in the electronic power system (when compared to sensed rotor position techniques) and to improve the reliability of the electric power steering system in the field.

Other objects, features and advantages will be apparent from the specification, the claims and the drawings.

### BRIEF DESCRIPTION OF THE DRAWINGS

FIG. 1A illustrates a vehicle with an electric power steering (EPS) system;

FIG. 1B is a functional block diagram and perspective view of the EPS system;

FIG. 2 illustrates a segmented stator and a rotor for a switched reluctance electric motor;

FIG. 3A illustrates a stator plate;

FIG. 3B identifies tooth width, projection width and stator pole arc on the stator plate of FIG. 3A;

FIG. 4 is a perspective view of a stator segment assembly associated with the stator;

FIG. 5 illustrates a switched reluctance drive circuit and a circuit board for connecting the drive circuit to terminals of the stator segment assemblies;

FIG. 6A shows the stator segment assembly with its wire windings and insulation removed to better illustrate a stack of stator plates and the end cap assembly;

FIG. 6B is a plan view of the end cap assembly shown in FIG. 6A;

FIG. 6C is an end view of the end cap assembly shown in FIG. 6B;

FIG. 7A is similar to FIG. 6A except that an alternate end cap assembly is shown;

FIG. 7B shows a plan view of the alternate end cap assembly of FIG. 7A; and

FIG. 7C illustrates an end view of the alternate end cap assembly shown in FIG. 7B.

### DETAILED DESCRIPTION OF THE PREFERRED EMBODIMENTS

The following detailed description provides preferred exemplary embodiments only and is not intended to limit the scope, applicability or configuration of the present invention. Rather, the detailed description of the preferred exemplary embodiments will provide those skilled in the art with an enabling description for implementing the preferred exemplary embodiments of the present invention. It will be understood that various changes may be made in the function and arrangement of the elements without departing from the spirit and scope of the invention as set forth in the appended claims.

An electric power steering (EPS) system according to the present invention includes a novel switched reluctance motor with a segmented stator. The EPS system with the segmented stator switched reluctance motor can be packaged in a smaller size for a given torque output and/or packaged at the same size with increased torque output. The novel segmented stator switched reluctance machine can be implemented using sensorless rotor position techniques while remaining cost competitive with other types of motors used in EPS systems.

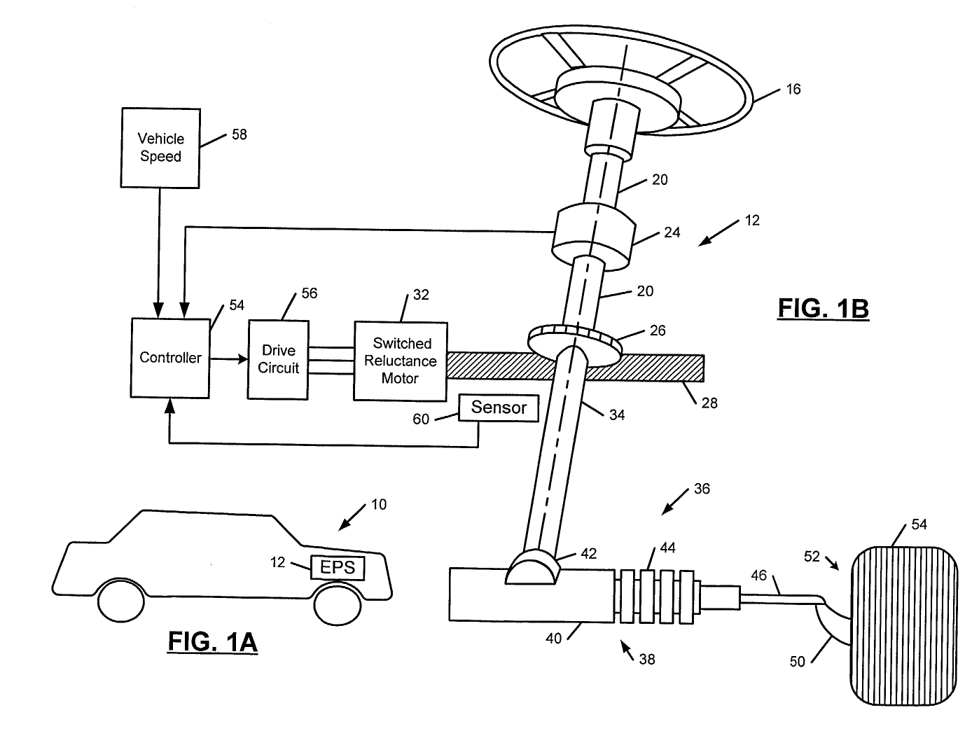

Referring now to FIGS. 1A and 1B, a vehicle 10 includes an electric power system steering (EPS) system 12. The EPS system 12 includes a steering wheel 16 that is connected to an upper steering shaft 20. A torque sensor 24 senses steering effort that is required to turn the steering wheel 16. A worm gear 26 is connected to the upper steering shaft 20 and is threadably engaged by a worm 28. The worm 28 is connected to a switched reluctance motor 32 that includes a segmented stator as will be described further below.

A lower steering shaft 34 is connected to a steering gear assembly 36. A universal joint (not shown) may be used between the lower steering shaft 34 and the steering gear assembly 36 if needed. In a preferred embodiment, the steering gear assembly 36 is a rack and pinion gear assembly 38. However, skilled artisans will appreciate that the steering gear assembly 36 can be a recirculating ball gear assembly or any other suitable steering gear assembly. The rack and pinion gear assembly 38 includes a steering gear rack housing 40 and a pinion gear housing 42. The steering gear rack housing 40 encloses a steering rack (not shown) that is connected to an inner tie rod (not shown). The pinion gear housing 42 encloses a pinion gear (not shown) that is connected at one end to the lower steering shaft 34 and whose teeth mesh with those on the steering rack. A dust boot 44 provides a flexible enclosure for the steering rack and the inner tie rods as they move laterally when the driver steers the vehicle 10. An outer tie rod 46 is connected at one end to the inner tie rod. An opposite end of the outer tie rod 46 is connected to a steering knuckle 50, which is connected to a rim 52 with a tire 54 mounted thereon.

An EPS system controller 54 is connected to a drive circuit 56 that controls the switched reluctance motor 32. The torque sensor 24 is connected to the EPS system controller 54. A vehicle speed sensor 58 preferably provides a speed signal to the EPS system controller 54. A rotational sensor 60 generates an angular position signal that is related to the angular position of the steering wheel 16, the upper steering shaft 20, and/or the wheel 52.

In use, the operator of the vehicle 10 turns the steering wheel 16 to turn the wheels 52 of the vehicle 10. The torque sensor 24 senses the amount of effort that is required to turn the steering wheel 16. The rotational sensor 60 senses the rotational position of the steering wheel 16, the upper steering shaft 20 and/or the wheel 52. The EPS system controller 54 factors the sensed torque, the speed of the vehicle 10, and/or the angular orientation of the steering wheel 16, the upper steering shaft 20 and/or the position of the wheels 52. The EPS system controller 54 sends a control signal to the drive circuit 56 that generates a set of currents that create a magnetic field.

Referring now to the drawings, the switched reluctance motor 32 is shown to include a housing 112, a segmented stator 114 mounted in the housing 112, and a rotor 116 supported for rotation relative to the segmented stator 114. In accordance with the present invention, the segmented stator 114 includes a plurality of stator segment assemblies 118 that can be individually assembled and subsequently interlocked to define the segmented stator 114. As will be detailed, each stator segment assembly 118 includes a stator segment core 120, an end cap assembly 122, and winding wire 124 that is wound around the stator segment core 120 and the end cap assembly 122. The end cap assembly 122 insulates the ends of the stator segment core 120 and provides retention for additional turns of the winding wire.

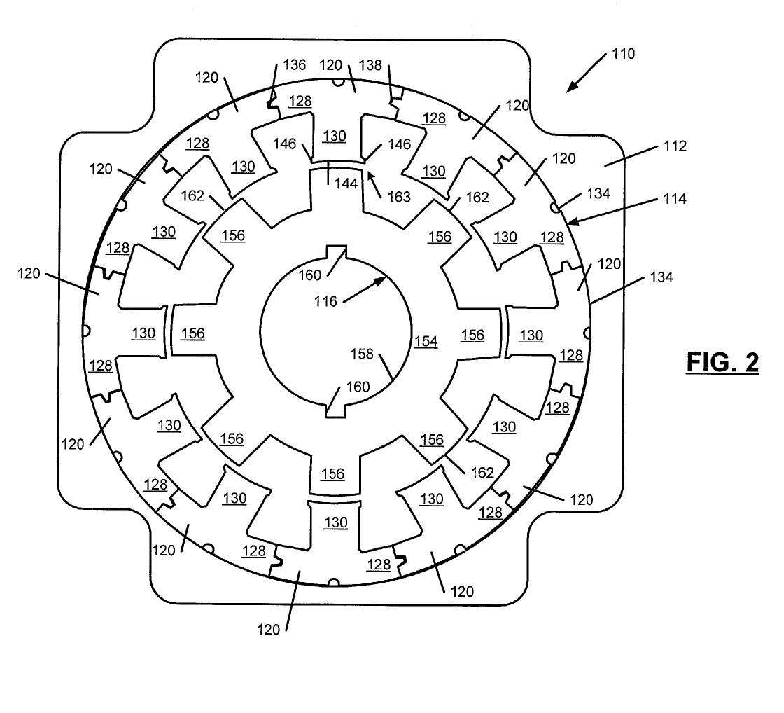

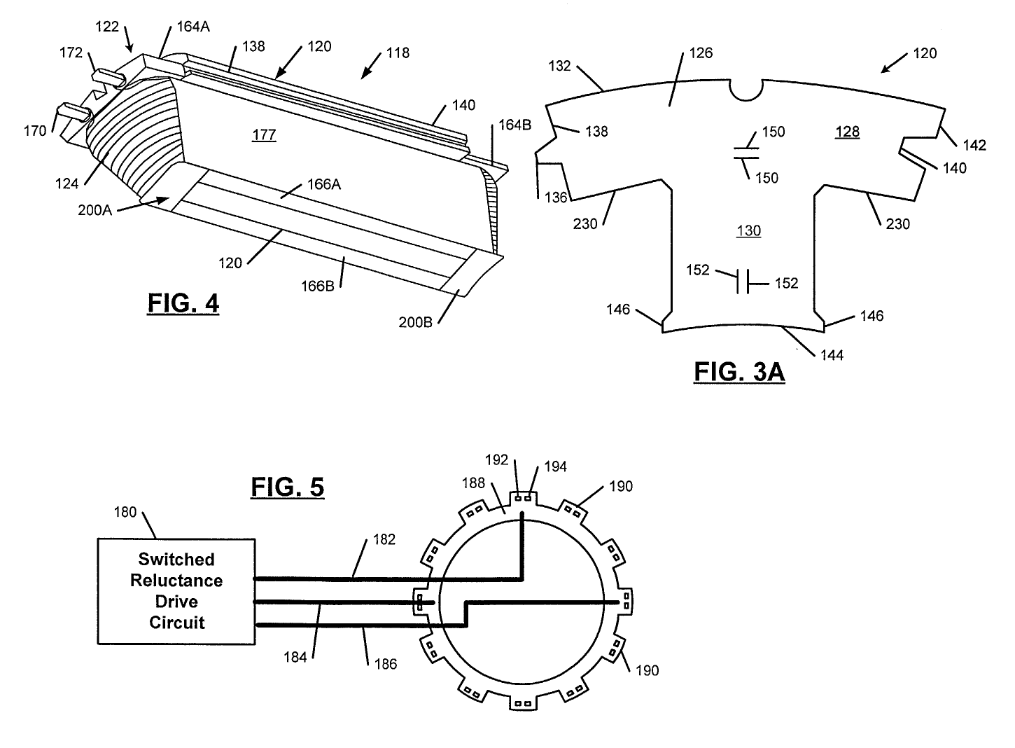

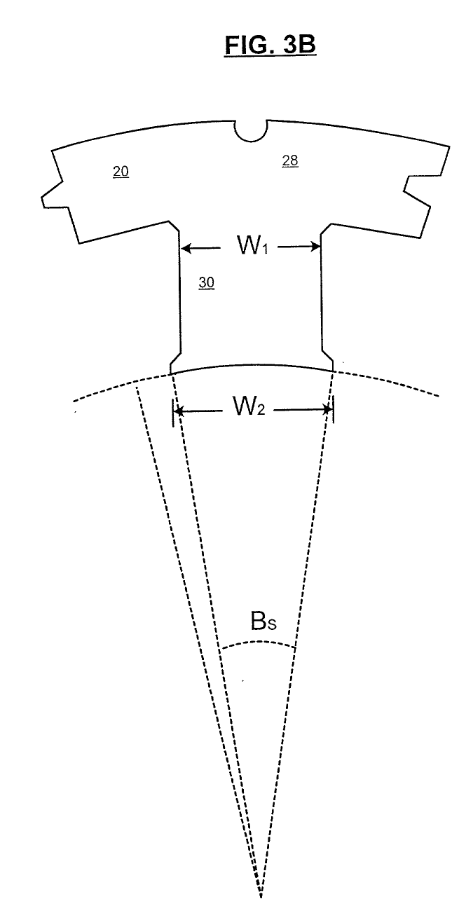

Referring primarily to FIGS. 2, 3A and 3B, the stator segment core 120 is comprised of a stack of individual stator plates 126. Each of the stator plates 126 include an arcuate outer rim section 128 and a tooth-shaped pole section 130. An outer edge surface 132 of the outer rim section 128 is shaped for mounting to an inner wall surface 134 of the housing 112. Each outer rim section 128 has a tongue projection 136 formed on one edge surface 138 and a groove 140 on its opposite edge surface 142. The tongues 136 and grooves 140 may be omitted since the stator segment assemblies 118 are typically press fit in the housing 112. Each pole section 130 of the stator plates 126 has an arcuate inner edge surface 144 and a pair of circumferentially-extending projections 146.

As previously mentioned, the stator segment core 120 is defined by a stack of the stator plates 126. The stator plates 126 are die cut from thin sheets of magnetically conductive material. During the die cutting operation, a first pair of slits 150 are cut into the outer rim section 128 and a second pair of slits 152 are cut into the pole section 130. Central portions between the slits 150 and 152 are deformed during the die cut operation. The slits 150 are transverse in alignment relative to the slits 152. The stator plates 126 are subsequently stacked and press fit together. This operation results in the stator plates 126 being releasably interconnected to define the stator segment core 120.

The rotor 116 is shown to include a circular rim section 154 and a plurality of tooth-shaped pole sections 156 that project radially from the rim section 154. A circular bore 158 is formed in the rotor 116 and may include keyways 160. A rotor shaft (not shown) is received by the circular bore 158 of the rotor 116. In the particular embodiment shown, the rotor 116 has eight equally-spaced rotor pole sections 156 and the segmented stator 114 has twelve equally-spaced pole sections 130. Other rotor pole and stator pole combinations are also contemplated. In addition, each rotor pole section 156 has an arcuate outer edge surface 162 that defines an air gap 163 with respect to the arcuate inner edge surface 144 on the pole sections 130 of the stator segment core 120.

Referring to FIG. 3B, tooth width W1, projection width W2, and stator pole arc Bs are shown. As a result of segmenting the stator, the designer of the switched reluctance electric machine has greater flexibility in designing the dimensions of the stator segment assemblies. The slot opening dimension between radially inner ends of the stator teeth restricts the projection width W2 when needle and transfer winding methods are employed. This restriction is eliminated when the segmented stator assemblies are employed because the stator teeth can be wound individually before being assembled into the stator.

The tooth width W1 determines the magnetic flux density in the stator tooth and how much area is available for winding wire in the inter-polar stator slot. The designer of the switched reluctance electric machine can select the tooth width W1 so that it is sufficient to accommodate the maximum anticipated magnetic flux in the stator poles, but is not wider than necessary. By optimizing the tooth width W1, the slot area is increased, which allows additional winding wire. By increasing the current carrying capacity of the windings without causing overheating, the torque density of the switched reluctance electric machine can be improved. The design of the stator plates also depends on other factors such as the type of steel that is selected, the axial length of the stator stack, the operating speed, the overall size of the motor, and the desired magnetic flux density in the stator teeth.

Referring to FIG. 4, the stator segment assembly 118 is shown fully assembled to include the stator segment core 120, the end cap assembly 122 and the winding wire 124. The end cap assembly 122 is preferably made from magnetically permeable material and includes a first end cap 164A, a second end cap 164B and a pair of elongated winding retainer sections 166A and 166B. The first end cap 164A is located at one end of the stator segment core 120 and the second end cap 164B is located at the opposite end of the stator segment core 120. The winding retainer sections 166A and 166B interconnect the first and second end caps 164A and 164B and are located adjacent to the projections 146 near the radially inner end of the pole sections 130 of the stator segment core 120. Preferably, the end caps 164A and 164B are similar in configuration. Likewise, it is preferable that the retainer sections 166A and 166B are similar in configuration. Snap-in connections are contemplated for connecting the opposite ends of each retainer section 166 to the end caps 164A and 164B. Additionally, it is contemplated that adhesives are used for bonding the end caps 164A and 164B to the opposite ends of the stator segment core 120. The end caps 164A and 164B and the retainer sections 166 can also be molded as an integral end cap assembly 122. Since the first end cap 164A is similar to the second end cap 164B, the following description of the components will use reference numerals with an “A” suffix for the first end cap 164A and the reference numerals for similar components of the second end cap 164B will be identical with a “B” suffix.

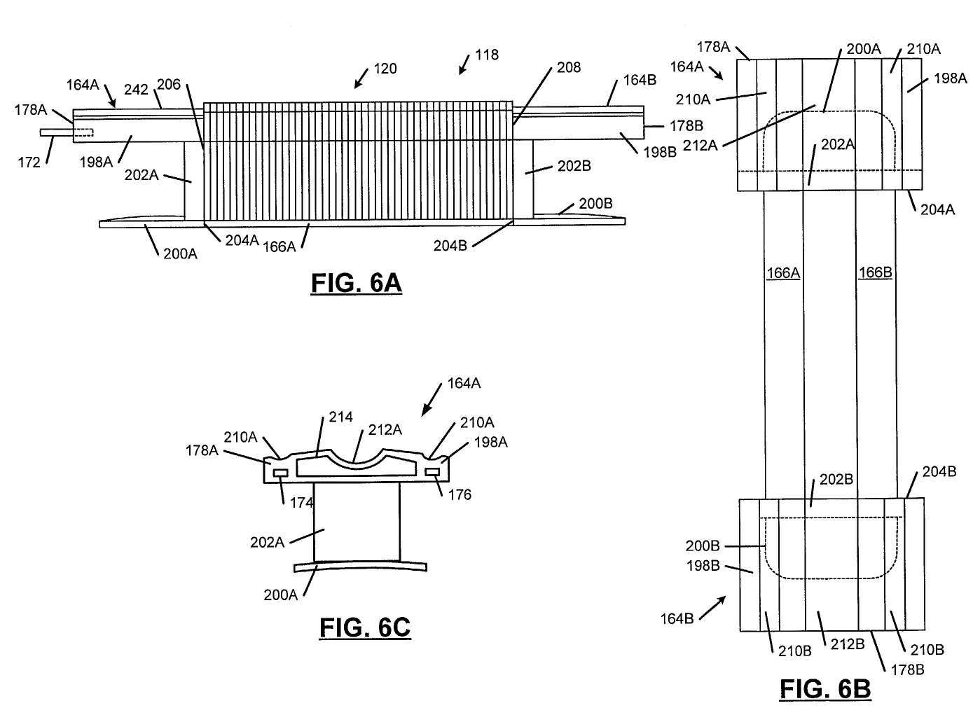

Terminals 170 and 172 are shown in FIGS. 4 and 6A to be mounted in slots 174 and 176 (FIG. 6C) formed in an end surface 178A of the first end cap 164A. One end of the winding wire 124 is connected to the first terminal 170 while an opposite end of the winding wire 124 is connected to the second terminal 172. Insulating material 177 is shown to be positioned to cover the winding wire 124 on both lateral sides of stator segment core 120. The insulating material 177 is also positioned (but not shown) between the stator segment core 120 and the winding wire 124.

Referring to FIG. 5, a switched reluctance drive circuit 180 is shown connected via connecting wires 182, 184 and 186 to a printed circuit board 188. The printed circuit board 188 is circular and has a plurality of radially outwardly projecting terminal pads 190. Each terminal pad 190 has conductive terminal slots 192 and 194 arranged to accept installation of the terminals 170 and 172 for each stator segment assembly 118. The drive circuit 180 operates to control energization of the winding wire 124 of the stator segment assemblies 118. In a preferred embodiment, the switched reluctance drive circuit 180 senses rotor position using sensorless techniques that are disclosed in U.S. Pat. Nos. 5,929,590 to Tang and 5,877,568 to Maes, et al., which are hereby incorporated by reference.

To more clearly illustrate the structure of the end cap assembly 122, FIG. 6A shows the stator segment assembly 118 prior to the insulating material 177 being installed and the winding wire 124 being wound thereon. The first end cap 164A includes an outer section 198A and an inner section 200A interconnected by a hub section 202A, all defining a common face surface 204A. The face surface 204A abuts and is bonded to an end surface 206 of the stator segment core 120. Similarly, the face surface 204B of second end cap 164B abuts and is bonded to an end surface 208 of the stator segment core 120. When the first end cap 164A is secured to the stator segment core 120, its outer section 198A extends slightly radially inward with respect to the outer edge surface of the outer rim section 128 and is parallel to the outer edge surface 132. The hub section 202A is aligned with pole section 130 and the inner section 200A is aligned with and extends laterally beyond the inner edge surface 144 and the projections 146. A similar alignment is provided when the second end cap 164B is secured to the opposite end surface 208 of the stator segment core 120. Moreover, the width of the hub sections 202A and 202B is less than or equal to the width of the pole sections 130 of the stator segment core 120. The opposite ends of the retainer sections 166A and 166B are connected to the face surfaces 204A and 204B of the end caps 164A and 164B, respectively, adjacent to their inner sections 200A and 200B. As such, the end cap assembly 122 defines a continuous annular channel within which the winding wire 124 can be precisely installed and maintained.

FIG. 6B shows the inner section 200A of the first end cap 164A and the inner section 200B of the second end cap 164B to be rectangular in shape. It is contemplated, however, that other configurations (i.e. semi-circular, square, tapered, etc.) could be used. As a further option, the retainer sections 166 could be provided as a cantilevered section that is integrally formed with the end caps 164A and/or 164B and adapted for connection to the inner section of the opposite end cap. To reduce the weight of the end cap assembly 122 and to simplify molding, lateral axial grooves 210 and a central axial groove 212 can be formed on the outer section of the end caps 164A and 164B. Likewise, a cavity 214 can also be formed to provide additional weight reduction and for simplifying the molding process.

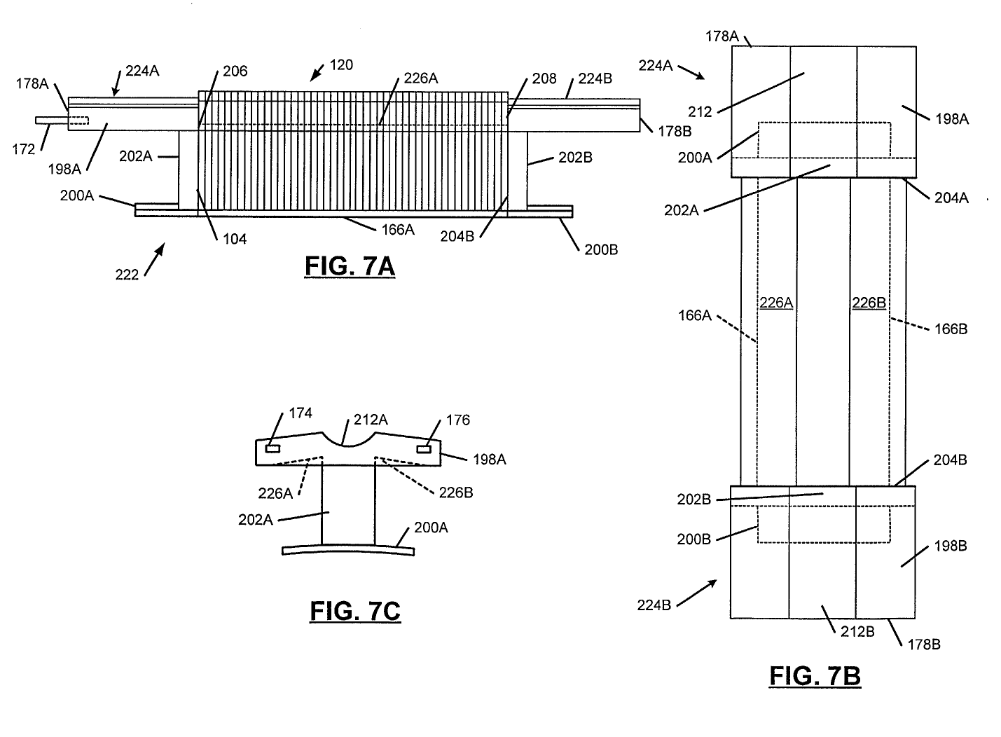

Referring now to FIGS. 7A, 7B and 7C, an alternative cap assembly 222 is shown for connection to the stator segment core 120 and supporting the winding wire 124. Reference numerals from FIGS. 6A, 6B and 6C will be used where appropriate to identify similar elements. Specifically, the first end cap 224A is generally similar to the first end cap 164A. The alternative end cap assembly 222 includes an additional pair of retainer sections. An outer retainer section 226A extends axially from the common face surface 204A adjacent to the outer section 198A for connection to the outer section 198B of the second end cap 224B. An outer retainer section 226B likewise extends axially from its common face surface 204B for connection to common face surface 204A of first end cap 224A. The outer retainer sections 226A and 226B provide additional support for the end cap assembly 122. The outer retainer sections 226A and 226B fill the arcuate inner edge 230 of the outer rim section 128. As a result, a substantially right angle projection to pole section 130 is formed. The outer retainer sections allow more precise control of the winding coil when performing precise winding and minimizes damage that may be caused by sharp edges defined by inner edge 230 and the edge surfaces 138 and 142. The outer retainer sections 226A and 226B have a tapered profile to mate with the profile of inner arcuate wall surfaces 230 (FIG. 2) of the outer rim section 128.

A significant benefit of the segmented switched reluctance motor of the present invention is the ability to maximize the inductance of the switched reluctance motor. In a conventional switched reluctance motor, the spacing between adjacent stator poles or teeth is determined by the wire size and the clearance that is required by the winding method. As the stator teeth spacing decreases, the inductance generally increases. In conventional switched reluctance motors, the spacing between the adjacent stator teeth is generally limited to the greater of the wire diameter or the clearance that is required by the winding method.

The switched reluctance motor according to the present invention, however, is not limited by either constraint. The spacing between adjacent stator teeth can be smaller than the wire diameter and is not limited by the winding method because the stator segment assemblies are wound before the stator is assembled. As a result, the inductance of the motor can be increased, which increases the impedance. Increasing the impedance decreases the drag load of the switched reluctance motor when an internal short circuit occurs during operation.

As can be appreciated from the foregoing, the EPS system with the segmented stator, switched reluctance electric motor improves the torque density of the electric motor by allowing the stator segment assemblies to be precisely wound. Slot fill between 70-95% is achievable depending upon the diameter of the motor and the diameter of the winding wire. As a result, the torque output for the electric motor can be increased. Alternately, the outer dimensions of the electric motor can be reduced for a given torque output.

The stator segment assemblies of the switched reluctance electric motor in the EPS system can be produced with a greater uniformity and with lower variations in inductance and resistance. As a result, sensorless rotor position sensing techniques can be employed, which dramatically lowers the manufacturing costs of the switched reluctance motor and improves reliability in the field. Because the manufacturing tolerances of the stator segments have been improved, less costly drive circuits can be employed and/or more accurate control can be achieved. In addition, the end cap assemblies according to the invention prevent winding creep and further help improve uniformity of the stator segment assemblies during use.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. An electric power steering system for a vehicle comprising:
a steering wheel;
a steering shaft connected to said steering wheel; and
a switched reluctance motor coupled to said steering shaft for reducing driver effort that is required to turn said steering wheel, wherein said switched reluctance motor includes a stator including a plurality of circumferentially-spaced stator segment assemblies that include a stack of stator plates forming a stator segment core and winding wire wound around said stator segment core, a rotor defining a plurality of rotor poles, wherein said rotor tends to rotate relative to said stator to maximize the inductance of an energized winding, and a drive circuit that energizes said winding wire around said stator segment assemblies based on a rotational position of said rotor.

2. The electric power steering system of claim 1 further comprising:
a worm gear connected to said steering shaft; and
a worm threadably engaged to said worm gear, wherein said rotor of said switched reluctance motor is connected to said worm.

3. The electric power steering system of claim 1 wherein each of said stator plates includes:
a radially outer rim section; and
a tooth section that extends radially inwardly from a center portion of said radially outer rim section.

4. The electric power steering system of claim 3 further comprising:
an insulation layer located between said winding wire and said stator segment core.

5. The electric power steering system of claim 1 further comprising:
projections extending from opposite sides of a radially inner end of said tooth section.

6. The electric power steering system of claim 5 further comprising:
first and second end caps connected to opposite axial ends of said stator segment core; and
first and second end cap retainer sections that extend along said projections and that connect said first and second end caps,
wherein said first and second end caps and said first and second end cap retainer sections reduce movement of said winding wire during use.

7. The electric power steering system of claim 1 wherein said stator plates of said stator segment core include radial and lateral slits and first and second central portions that are deformed using a punch and press fit to hold said stack of stator plates together.

8. The electric power steering system of claim 1 wherein said drive circuit senses rotor position using sensorless techniques.

9. An electric power steering system comprising:
a steering wheel;
a steering shaft connected to said steering wheel;
a switched reluctance motor coupled to said steering shaft for reducing driver effort that is required to turn said steering wheel; and
a stator for said switched reluctance motor including a plurality of circumferentially-spaced stator segment assemblies that are arranged around an inner surface of said motor housing, each of said stators segment assemblies defining a salient stator pole that extends in a radially inward direction, wherein inter-pole stator slots are defined between adjacent stator segment assemblies, and said stator segment assemblies including a stack of stator plates forming a stator segment core and winding wire that is wound around said stator segment core.

10. The electric power steering system of claim 9 further comprising:
a worm gear connected to said steering shaft; and
a worm threadably engaged to said worm gear, wherein said rotor of said switched reluctance motor is connected to said worm.

11. The electric power steering system of claim 9 wherein each of said stator plates includes:
a radially outer rim section; and
a tooth section that extends radially inwardly from a center portion of said radially outer rim section.

12. The electric power steering system of claim 11 further comprising:
an insulation layer located between said winding wire and said stator segment core.

13. The electric power steering system of claim 9 further comprising:
projections extending from opposite sides of a radially inner end of said tooth section.

14. The electric power steering system of claim 13 further comprising:
first and second end caps connected to opposite axial ends of said stator segment core; and
first and second end cap retainer sections that extend along said projections and that connect said first and second end caps,
wherein said first and second end caps and said first and second axial end cap retainer sections reduce movement of said winding wire during use.

15. The electric power steering system of claim 9 wherein said stator plates of said stator segment core include radial and lateral slits and first and second central portions that are deformed to hold said stator segment core together.

16. An electric power steering system for a vehicle comprising:
a steering wheel;
a steering shaft connected to said steering wheel; and
a switched reluctance motor that is coupled to said steering shaft to reduce driver effort that is required to turn said steering wheel, said switched reluctance motor including a motor housing, a rotor that rotates relative to said motor housing, and a stator that is mounted on an inner surface of said motor housing, said stator including a plurality of circumferentially-spaced stator segment assemblies, wherein said stator segment assemblies include a stack of stator plates forming a stator segment core and winding wire that is wound around said stator segment core, wherein each of said stator plates has a generally “T”-shaped cross-section, a radially outer rim section, and a tooth section that extends radially inwardly from a center portion of said radially outer rim section.

17. The electric power steering system of claim 16 further comprising:
a worm gear connected to said steering shaft; and
a worm threadably engaged to said worm gear, wherein said rotor of switched reluctance motor is connected to said worm.

18. The electric power steering system of claim 16 further comprising:
an insulation layer located between said winding wire and said stator segment cores.

19. The electric power steering system of claim 16 further comprising:
projections extending from opposite sides of a radially inner end of said tooth section.

20. The electric power steering system of claim 19 further comprising:
first and second end caps connected to opposite axial ends of said stator segment core; and
first and second end cap retainer sections that extend along said projections and that connect said first and second end caps,
wherein said first and second end caps and said first and second end cap retainer sections reduce movement of said winding wire during use.

21. The electric power steering system of claim 16 wherein said stator plates of said stator segment core include radial and lateral slits and first and second central portions that are deformed to hold said stator segment core together.

22. The electric power steering system of claim 16 further comprising:
a drive circuit connected to said winding wire of said stator segment assemblies, wherein said drive circuit senses rotor position using sensorless rotor techniques position.
